(19) United States
(12) Patent Application Publication
(10) Pub. No.: US 2008/0237101 A1
(43) Pub. Date: Oct. 2, 2008

(54) Temporary Potable Water Storage and Dispensing System

(75) Inventors: Bryan M. Roussel, Metairie, LA (US); Jason A. Dodgen, Marrero, LA (US)

Correspondence Address: Bryan M. Roussel, 223 Atherton Drive, Metairie, LA, 70005, US

(73) Assignees: Bryan Michael Roussel, Metairie, LA (US); Jason Albert Dodgen, Marrero, LA (US)

(21) Appl. No.: 11/694,189

(22) Filed: Mar. 30, 2007

(51) Int. Cl. C02F 1/00

(52) U.S. Cl. 210/167.1

(57) ABSTRACT

A temporary emergency water storage system provided for use in emergencies, such as hurricanes, typhoons, cyclones, winter storms and other natural disasters in which municipal and/or fresh water supplies are cut off or rendered impure or un-potable. The temporary water storage can also be used to provide a supply of water in times of man made disasters, such as war or acts of terrorism or vandalism which can render municipal water supplies suspect or unusable. The temporary emergency water storage device is used in conjunction with the building's bathing pools. The bathing pool's water supply provides the source of the potable water that is stored prior to plan use. The temporary emergency water storage system includes a flexible storage bag for storing the protected potable water and pump for dispensing the potable water. The temporary water storage system is collapsible and portable

### CROSS-REFERENCE TO RELATED APPLICATIONS

This application claims the benefit of provisional patent application Ser. No. US60/651,171, filed Feb. 9, 2005 by the present inventors.

### STATEMENT REGARDING FEDERALLY SPONSORED RESEARCH OR DEVELOPMENT

Applicable

### REFERENCE TO SEQUENCE LISTING, A TABLE, OR A COMPUTER

Not Applicable

### PROGRAM LISTING COMPACT DISC APPENDIX

Not Applicable

### BACKGROUND OF THE INVENTION

### Field of Invention

The invention is in the field of water storage devices. More particularly, the present invention relates to devices of the type used to store a supply of emergency potable water in or around a dwelling. The idea of storing water for emergencies is not new and there are many solutions. The first group is permanent water storage. In a permanent water storage solution, water will be stored at all times and will be available without preparations taken before an event that will cause the dwelling primary source of water to be unavailable. The other group is for temporary emergency water storage, when preparations are taken to store water before the event that will cause the dwelling primary source of water to be unavailable.

For permanent emergency water storage there are several variants of water storage tanks that are permanently attached to the dwelling's plumbing. Such as U.S. Pat. No. 2,931,382, issued 5 Apr. 1960 to F. Cirillo and S. Scata or U.S. Pat. No. 3,095,893, issued 2 Jul. 1963 to J. Martin. These solutions require costly permanent building modifications and maintenance.

The other variants for permanent water storage have a water storage tank attached to a dwellings faucet instead of permanent plumbing modifications. Such as U.S. Pat. No. 4,718,452, issued 12 Jan. 1988 to D. Maitland, U.S. Pat. No. 5,029,612, issued 9 Jul. 1991 to V. Simbulan, or U.S. Pat. No. 5,778,471, issued 14 Jul. 1998 to T. Collison, etc. While these do not require permanent plumbing modifications they are still costly, bulky and will require maintenance.

For Temporary emergency water storage containers in various sizes such as 55 gal drums, 5 or 1 gal jugs are commercially available. The problem with this solution is that it requires significant space to store these bulky water containers until they are needed. Alternatively some vendors sell flexible water storage bags. The flexible water storage bags are not bulky however these reusable containers need to be cleaned between uses, and are designed to be elevated and the water dispensed by gravity. Additionally these bags do not have any method of containment in case of leaks or failure.

Another alternative to storing enough water for an event where the primary water source is unavailable for several days is to store water in a bathtub. This idea has been recommended by FEMA, Red Cross, local TV and Newspapers, etc. However there are several problems with storing water directly in a bathtub. First the tub would need to be disinfected, second the tub drain would need to be sealed, and finally the water stored in a bathtub has a large opening that would easily allow the water to be contaminated by the environment.

### BRIEF SUMMARY OF THE INVENTION

Disclosed is an apparatus and method for temporary potable water storage and Dispensing in preparation for situation where normal potable water sources will or have a high probability of being interrupted, such as in preparation for situations such as hurricanes, severe winter storms, pending water outages due to municipal or local water systems repairs Also disclosed is a system consisting of a flexible bladder that will be supported by typical household bathing pool to store and protect the potable water and a pumping apparatus to dispense the water when needed. The majority of residential dwellings contain “bathrooms” which include ” bathing pools”, commonly known as” bathtubs”, used by the inhabitants of the dwelling for personal hygiene. The availability of the bathing pool and the easy access to potable water and typically has volume with capacities up to 65 gallons. This system is designed to enhance the ability to store potable water in a dwelling bathing pool with the advantage of being lightweight, portable, cost effective and easy to store before needed.

### BRIEF DESCRIPTION OF THE SEVERAL VIEWS OF THE DRAWING

The features of the invention believed to be novel are set forth in the appended claims. The invention however together with further objects and advantages thereof, may be best understood by the reference to the following description taken in conjunction with the accompanying drawing(s) and appendices summarized below

FIG. 1 is a perspective view of the Temporary Potable Water Storage and Dispensing System and components in accordance with the embodiment of the invention.

FIG. 2 is a section view of the Temporary Potable Water Storage and Dispensing System illustrating the fill operation mode.

FIG. 3 is a section view of the Temporary Potable Water Storage and Dispensing System illustrating the storage mode.

FIG. 4 is a section view of the Temporary Potable Water Storage and Dispensing System illustrating the dispensing operation mode.

### DETAILED DESCRIPTION OF THE INVENTION

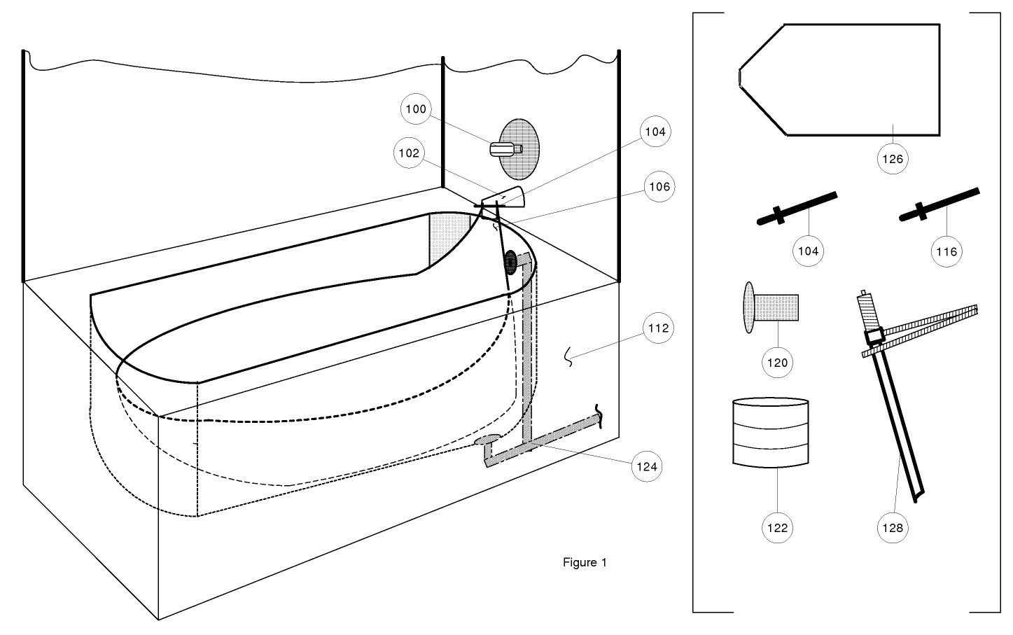

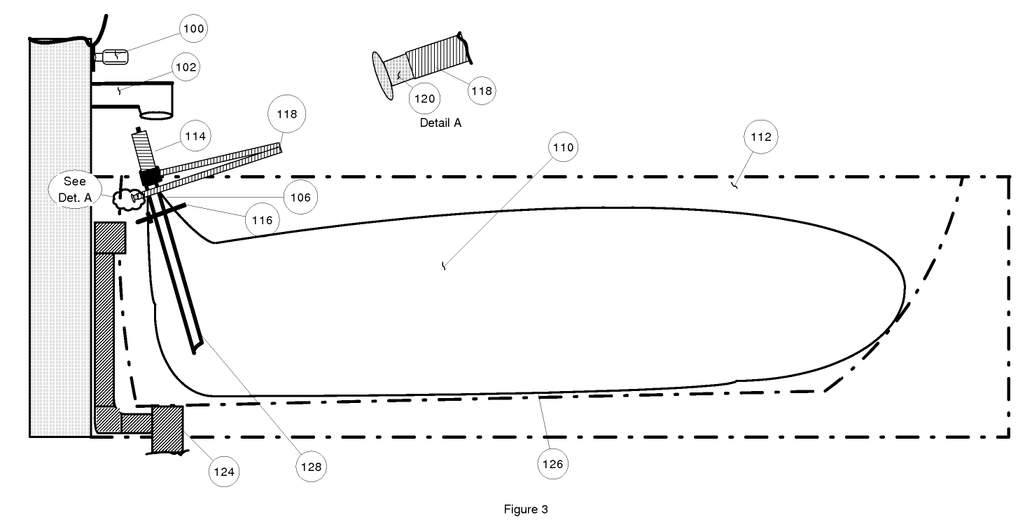

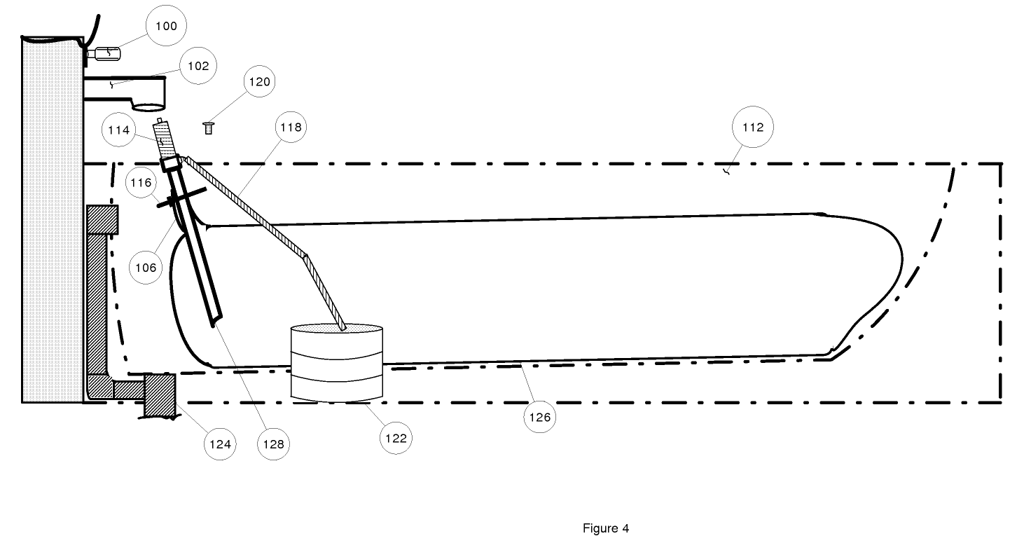

FIG. 1. Illustrates the Temporary Potable Water Storage and Dispensing System 1 in accordance with an embodiment of the invention. The Temporary Potable Water Storage and Dispensing System consist of flexible bladder 126, which is made from flexible United States Food and Drug Administration (FDA) approved material for storing water and food product. The flexible bladder is shaped such that it has an opening 106 that is easily adapted to various sizes bathing pool plumbing system spouts 102 and a dispensing pump 128. The pump 128 that is used to dispense or move the potable water from the storage bladder 126 to an outside container 122 that will be used to transport the potable water for consumption. Flexible locking straps 104 and 116 are used to secure the flexible bladder to the potable water fill source, spout 102, during the fill operation and to the pump 128 during storage and dispensing modes FIG. 3 and FIG. 4. Stopper 120, which is made from food and water safe product, is used to seal the dispensing tube of the pump 128 during the storage mode FIG. 3.

In FIG. 1 the bathing pool 112, which is available in almost every household across the United States and many foreign countries around the world, is the rigid-support container for the flexible bladder 126. The bathing pool 112 provides a secure and safe container for the flexible bladder 126, since a drainage system 124 is typically part of the bathing pool 112 capabilities. If the flexible bladder 126 has a rare occurrence of failure or if the user over fills the bladder 126 the bathing pool drain 124 disposes of the water. Bathing pools vary in size but the average bathing pool holds approximately 65 gallons of water. Bathing pools 112 are typically configured with plumbing systems, a water supply valve 100, and water spout 102, to supply water to the bathing pool 112 and a drain 124 to drain the water from the bathing pool 1 12. The bathing pool 112, the water supply 100, and the drain 124 provide the infrastructure requirements for the temporary potable water storage and dispensing system.

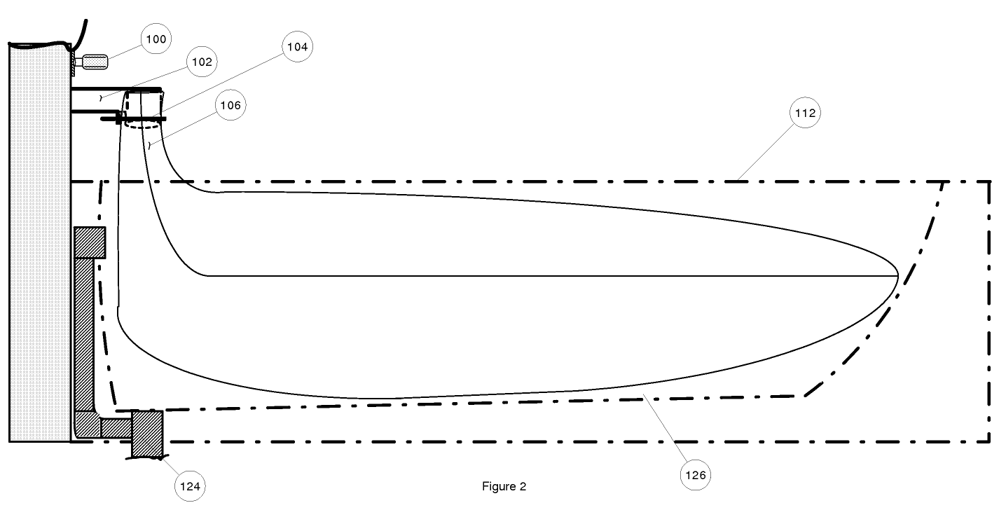

FIG. 2 depicts a section view of the fill operation. The potable water can be supplied in any number of ways known in the art. The the flexible bladder opening 106 is affixed to the bathing pool spout 102 and secured with flexible locking strap 104. The bladder 126 is spread across the bottom of the bathing pool 1 12. The bladder 126 is filled with potable water by opening tub valve 100.

FIG. 3, is a section view depicting the Temporary Potable Water Storage and Dispensing System in the storage mode. When the flexible bladder 126 is filled, flexible locking strap 104 is removed and the flexible bladder opening 106 is removed from the water spout 102.

Preparation for water storage begins with inserting the suction side of pump 114 into the bladder opening 106. The pump body 114 is secured to the bladder opening 106 with the use of the flexible locking strap 1 16. The pump dispensing tube stopper 120 is then inserted into the end of the pump dispensing tube 118, thus sealing the water in the portable water storage and dispensing system.

Turning to FIG. 4, water is dispensed from the Temporary Potable Water Storage and Dispensing System for consumption The dispensing operation is performed by placing a sanitized container 122 next to the dwelling's bathing pool 1 12. The pump dispensing tube stopper 120 is removed from the end of the pump dispensing tube 118. The end of the pump dispensing tube 118 is then placed into the water storage container 122. Operating the pump 128 performs the transfer of the water from the flexible bladder 126 to the container 122. The art does not rely on gravity to dispense the water. Dispensing of the water can be performed with any number of pump types known in the art. One pump type illustrated for example, not limitation.

Typical bathing pool 112 designs will cause the water in the flexible bladder 126 to collect toward the bladder opening 106 and dispensing pump 128 This will allow for the majority of water to be easily dispensed.

Once the water has been depleted, the pump 128 is available for reuse with additional flexible bladders 126. The bladder 126 is a one time use product and must be replaced with each use.

We claim:

1. A system to easily store and dispense a large quantity of potable water temporarily in a dwelling comprising: a bathing pool with plumbing, a means for containment and protecting the water from contamination and a pump for dispensing the water.

2. The system of claim 1, wherein using the bathing pool plumbing already in place for easily filling and draining a large quantity of potable water.

3. The system of claim 1, wherein using the bathing pool as a bladder container for storing a large quantity of potable water.

4. The system of claim 1, wherein said means for containment and protecting the potable water from contamination comprising a flexible protective bladder placed in the bladder container.

5. The apparatus in claim 4, wherein said flexible protective bladder easily adapts to the various shapes and sizes of common bathing pools.

6. The apparatus in claim 4, wherein said protective bladder is flexible to allow temporary attachment to bathing pool spout for easy filling.

7. The apparatus in claim 4, wherein said protective bladder is flexible to allow attachment to a pump to dispense the potable water.

8. The apparatus in claim 4, wherein said flexible protective bladder is substantially collapsible so that it stores in little space before needed.
